(19) United States
(12) Patent Application Publication
(10) Pub. No.: US 2012/0032056 A1
(43) Pub. Date: Feb. 9, 2012

(54) Cribbing for use in Industrial Tank Cleaning

(76) Inventor: Rene Fabian Mora, Norwalk, CA (US)

(21) Appl. No.: 13/164,526

(22) Filed: Jun. 20, 2011

Related U.S. Application Data
(60) Provisional application No. 61/370,537, filed on Aug. 4, 2010.

(51) Int. Cl. F16M 13/00

(52) U.S. Cl. 248/351

(57) ABSTRACT

This invention relates to a cribbing for use in industrial tank cleaning. The cribbing is constructed from elongated wooden chocks. Each chock has notches at predetermined distances from the ends of the chocks, with the notches being located on the upper and lower surfaces of the chocks. The cribbing is constructed by interlocking the chocks together at the notches, creating layers which may be stacked on top of each other. The layers are stacked to a pre-determined height dependent on environmental conditions. The chocks may be coated with a chemically resistant substance to prevent chemical corrosion of the chocks.

### PRIORITY

Priority is claimed based on the Aug. 4, 2010 filing of provisional application 61/370,537, said application being specifically incorporated herewith in its entirety by reference for all purposes.

### BACKGROUND OF THE INVENTION

This invention relates to an improved crib for use in supporting the top of a chemical tank while the tank is being cleaned.

Manufacturing and other industries use tanks to store chemicals in for later use. The tanks are cylindrical in shape and covered with a roof which floats on the surface of the chemicals. The floating roof has a plurality of leg supports attached to the underside which keeps the floating roof from reaching the bottom of the tank when all of the liquid chemical has been removed from the tank.

While the tanks are often used over long periods of time for storage of the same chemicals, sometimes the tanks are used to store different chemicals. Before a different chemical can be placed into the tank for storage, the tank needs to be cleaned. Also, the tanks need to be cleaned periodically to remove debris that may have settled out of the stored chemicals. The chemicals stored in the tanks are often caustic in nature, which can lead to deterioration of the tank floating roof and the leg supports. During the cleaning process, all of the chemicals are drained from the tank. Prior to cleaning, however, cribbing is installed inside the tanks. Among other things, the cribbing protects workers in the tanks in the event that one or more of the support legs fails. In the absence of cribbing, a failure of the leg supports could result in serious injuries to workers or even fatalities.

Traditionally, the support cribbing consists of wooden pallets or other wooden members stacked on top of each other. Separate cribs are placed at various locations on the ground level, and typically are built to a height of 6 feet each. This allows room for workers to walk around underneath the supported floating roof.

A similar product is used in the mining industry; see U.S. Pat. No. 5,746,547. The invention disclosed therein requires that the cribbing contain a solid wall to contain the grout or sand that stabilizes the cribbing. The invention disclosed herein allows for a cheaper cribbing while providing the necessary support for loads experienced in the tanks used in the manufacturing industry. Solid walls are not required with the cribbing because no grout or other substance is needed to stabilize the cribbing. By building the cribbing where the chocks do not rest on each other completely, but only at the notches, fewer chocks are required to support the loading. This means the cribbing is cheaper to build.

One problem with the cribbing currently used in the manufacturing industry is that when the leg supports of a floating roof fail, the floating roof often will tilt thereby imposing lateral forces on the cribbing. The currently used cribbing is strong when confronted by vertical compressive forces, but fails when confronted with lateral forces. The currently designed crib also tends to separate into individual member units when confronted with lateral forces. This could endanger the lives of workers cleaning the tank, as there is no room for the worker between the heavy tank floating roof and the bottom of the tank. Another problem with traditional cribbing is that the wood members tend to absorb some of the chemicals remaining in the tank. This prevents the cribbing from being used in the cleaning process of other tanks where different chemicals were stored.

### BRIEF DESCRIPTION OF THE DRAWINGS

FIG. 1 contains a trimetric view of a chock component of the Cribbing for use in Industrial Tank Cleaning according to the preferred embodiment of the present invention.

FIG. 2 contains a front view of a chock component of the Cribbing for use in Industrial Tank Cleaning according to the preferred embodiment of the present invention.

FIG. 3 contains a back view of a chock component of the Cribbing for use in Industrial Tank Cleaning according to the preferred embodiment of the present invention.

FIG. 4 contains a top view of a chock component of the Cribbing for use in Industrial Tank Cleaning according to the preferred embodiment of the present invention.

FIG. 5 contains a bottom view of a chock component of the Cribbing for use in Industrial Tank Cleaning according to the preferred embodiment of the present invention.

FIG. 6 contains a left side view of a chock component of the Cribbing for use in Industrial Tank Cleaning according to the preferred embodiment of the present invention.

FIG. 7 contains a right side view of a chock component of the Cribbing for use in Industrial Tank Cleaning according to the preferred embodiment of the present invention.

FIG. 8 contains a front view of a chock component of the Cribbing for use in Industrial Tank Cleaning according to the preferred embodiment of the present invention.

FIG. 9 contains a trimetric view of the Cribbing for use in Industrial Tank Cleaning according to the preferred embodiment of the present invention.

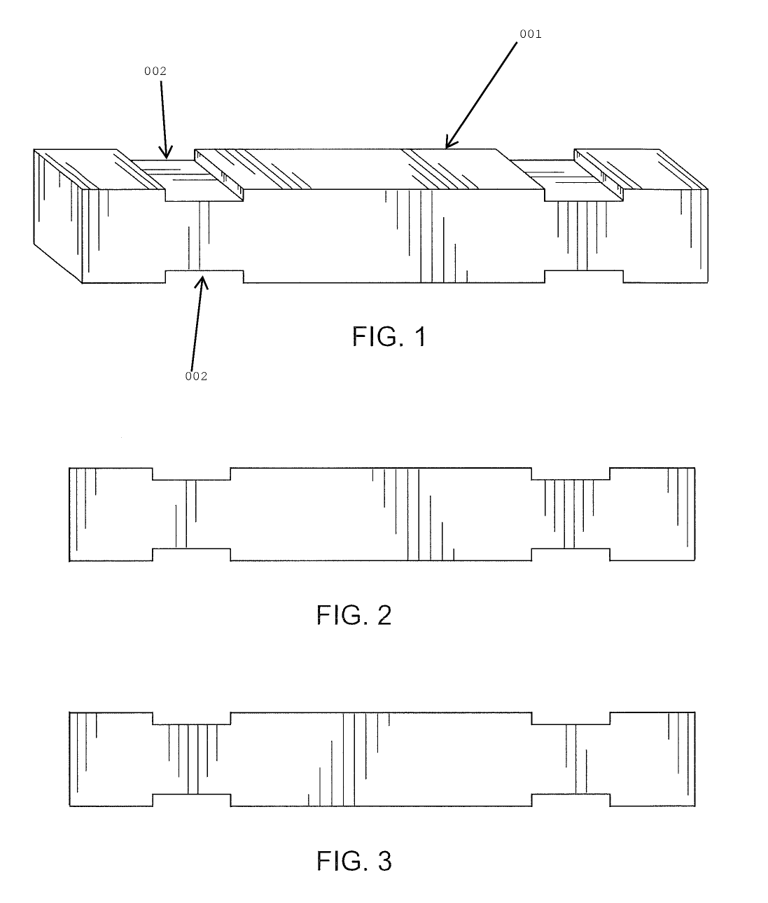

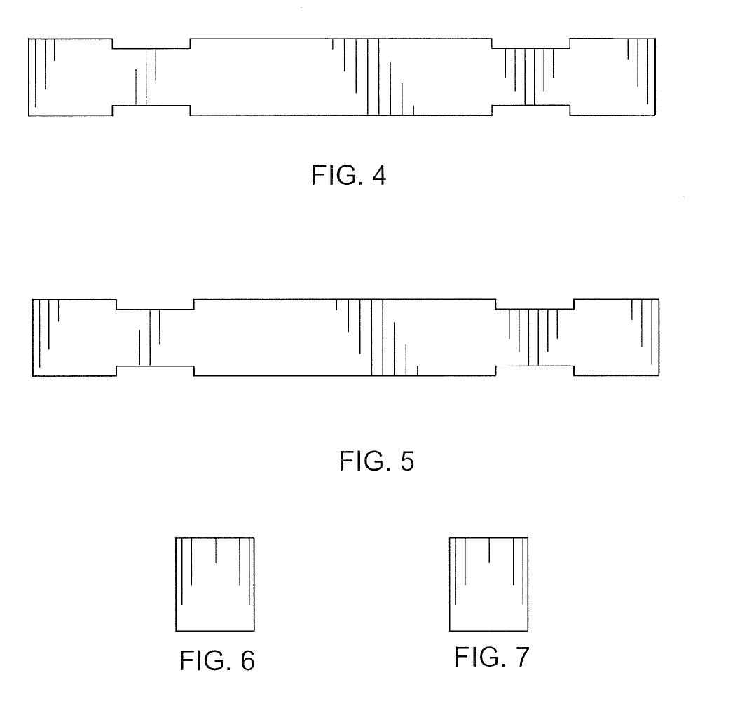

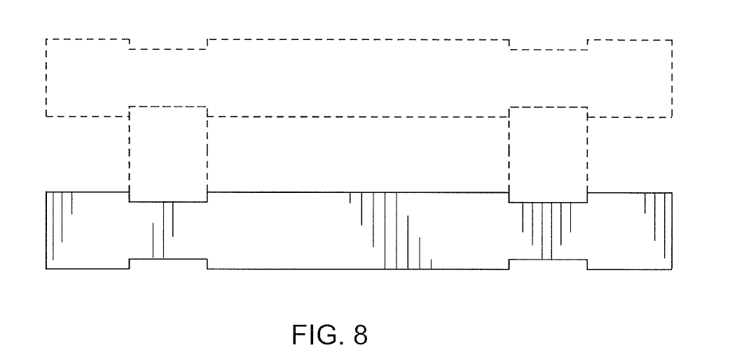

### DETAILED DESCRIPTION OF INVENTION

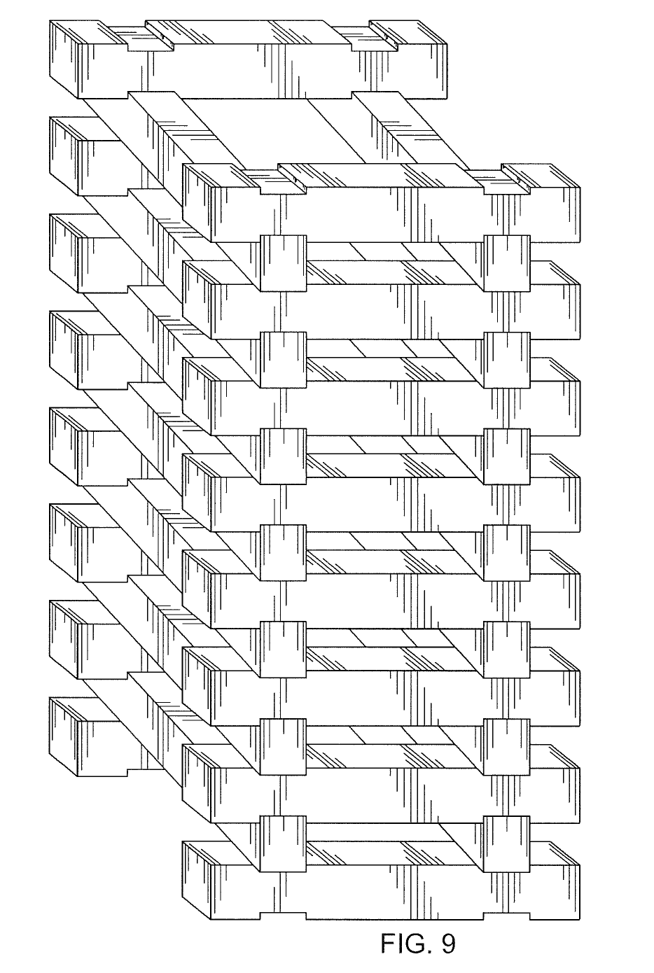

An object of this invention is to build a safer cribbing (FIG. 9) that can resist lateral forces. This object is accomplished by constructing the cribbing out of a series of layers of elongated members called chocks (001), with a plurality of parallel spaced apart chocks in each layer. Each chock is constructed out of a dense material. Each chock is rectangular in shape, being approximately four feet (4′) in length, and five and a half inches (5.5″) in width and in height. In the preferred embodiment, the chocks are constructed from solid hardwood, such as oak. However, any type of wood may be used or even other materials such as plastic, if the material is of sufficient density to resist the compressive forces imposed by the load. All surfaces of each chock should be relatively flat to prevent loading of the assembly at unintended points.

Each chock in one layer is arranged transversely to each chock in the adjacent layer or layers so that the chocks in a superimposed layer cross the chocks in the layer below at at least two crossing points. The crossing points are located inwardly of the ends of the chocks at notches (002) cut into the chocks. The notches should be cut at an uniform distance from the ends of the chocks. In the preferred embodiment, each notch is cut six inches (6″) from each end of the chock. Each notch should span the entire width of the chock to a pre-determined depth. In the preferred embodiment, each notch is cut to a length of six inches (6″) and to a depth of one and a half inches (1.5″).

The notches interlock with one another to lock the chocks together. The notches are of such a depth that the portions of the chocks which are located between and beyond the notches do not bear on corresponding portions of the chocks in the superimposed layers. The crib, as construct is more stable than the prior art, less likely to tip over in the event of a shifting of the tank floating roof, and more likely to remain together as one piece than to come apart into separate units like the prior art tends to do.

Another object of this invention is to build a crib less likely to be contaminated by any chemicals in the tank. This object is accomplished by coating the chocks with plastic resins to seal the pores of the chock. There are a number of commercially available resins that could be used to accomplish this objective, and anyone familiar in the industry would be well acquainted with the various resins available. After the tank cleaning process is completed, the chocks can themselves be cleaned by using a readily available commercial solvent specific for the type of chemical being stored in the tank.

I claim:

1. A cribbing for use in industrial tank cleaning comprising:
a series of layers of elongated chocks with a plurality of parallel, spaced apart chocks in each layer;
each chock being constructed from a dense material;
each chock in one layer being arranged transversely to each chock in the adjacent layer so that the chocks in a superimposed layer cross the chocks in the layer below at least two crossing points which are located inwardly of the ends of the chocks;
wherein operative upper and lower surfaces of the chocks in superimposed layers are formed with notches at the crossing points;
the notches interlocking with one another to lock the chocks together;
the notches being of such depth that portions of the chocks which are located between and beyond the notches do not bear on corresponding portions of the chocks in the adjacent layers.

2. The cribbing for use in industrial tank cleaning of claim 1 wherein the chock is constructed from wood.

3. A cribbing for use in industrial tank cleaning comprising:
a series of layers of elongated chocks with a plurality of parallel, spaced apart chocks in each layer;
each chock being constructed from a dense material;
each chock in one layer being arranged transversely to each chock in the adjacent layer so that the chocks in a superimposed layer cross the chocks in the layer below at least two crossing points which are located inwardly of the ends of the chocks;
wherein operative upper and lower surfaces of the chocks in superimposed layers are formed with notches at the crossing points;
the notches interlocking with one another to lock the chocks together;
the notches being of such depth that portions of the chocks which are located between and beyond the notches do not bear on corresponding portions of the chocks in the adjacent layers;
the chocks being coated with a chemically resistant resin.

4. The cribbing for use in industrial tank cleaning of claim 3 wherein the chock is constructed from wood.

5. A cribbing for use in industrial tank cleaning comprising:
a series of layers of elongated chocks with a plurality of parallel, spaced apart chocks in each layer;
each chock being constructed from a chemically resistant dense material;
each chock in one layer being arranged transversely to each chock in the adjacent layer or layers so that the chocks in a superimposed layer cross the chocks in the layer below at least two crossing points which are located inwardly of the ends of the chocks;
wherein operative upper and lower surfaces of the chocks in superimposed layers are formed with notches at the crossing points;
the notches interlocking with one another to lock the chocks together;
the notches being of such depth that portions of the chocks which are located between and beyond the notches do not bear on corresponding portions of the chocks in the adjacent layers.
